(19) United States
(12) Patent Application Publication
(10) Pub. No.: US 2014/0040871 A1
(43) Pub. Date: Feb. 6, 2014

(54) MOBILE BUILD, QUALITY AND DEPLOYMENT MANAGER

(71) Applicant: Solstice Consulting, LLC, Chicago, IL (US)

(72) Inventors: J Schwan, Glen Ellyn, IL (US); Andrew Jeremiah Whiting, Chicago, IL (US); Graham Haworth, Chicago, IL (US)

(73) Assignee: Solstice Consulting, LLC, Chicago, IL (US)

(21) Appl. No.: 13/958,103

(22) Filed: Aug. 2, 2013

Related U.S. Application Data
(60) Provisional application No. 61/678,880, filed on Aug. 2, 2012.

(51) Int. Cl. G06F 9/45

(52) U.S. Cl. CPC G06F 8/43
USPC 717/141

(57) ABSTRACT

The present technology relates to computer implemented methods and systems for managing mobile applications by executing various routines on one or more computers in connection with the mobile applications. The present technology can involve routines and tools that download source code from a code repository. The present technology automatically builds the source code to create an executable build. The present technology can perform a check on the executable build according to a defined quality control rule, and communicate the executable build to an application repository. In certain aspects, the present technology can monitor application metrics and generate reports relating to the application metrics. In certain embodiments, the present technology compiles a launchability metric that establishes the mobile application's readiness for launch.

### RELATED APPLICATIONS

This application claims priority to U.S. Provisional Patent Application No. 61/678,880, which was filed on Aug. 2, 2012, and titled “Mobile Build, Quality and Deployment Manager.” U.S. Provisional Patent Application No. 61/678,880 is hereby incorporated by reference in its entirety.

### BACKGROUND

Mobile applications (or mobile apps) are applications developed for small handheld devices, such as mobile phones, smartphones, PDAs and the like. Mobile apps can come preloaded on the handheld device, and they can be downloaded by users from various resources such as app stores and the internet, for example. Occasionally, developers may desire to provide updates to mobile apps to include new information, repairs, new software, or other functionality, for example. In this manner, users of mobile devices can manually select updates to their apps or their mobile devices can update their apps automatically.

The various tasks involved in the process for developing, checking, releasing and deploying apps are often performed by multiple, unrelated entities, which may involve different teams using several different desktop computers. For example, code for mobile applications may be written or developed on desktop computers using a mobile application development environment. The developers may maintain one or more versions of the code for each application in a database or a code repository. When it is desired to release a version of an app, a releasing entity may choose a correct version of the code residing in the code repository using a desktop computer, and then manually compile the code into a mobile build. Additionally, a quality check entity may then use a personal computer to run mobile code quality checks on the code, or on the build. Further, a deployment entity may then deploy the builds to internal or external app stores through an external system, such as a web based graphical user interface (“GUI”), for example. Moreover, the metrics that can be reported on these processes are limited to the individual tasks, and not to the entire process as a whole. Accordingly, because this process involves several steps performed by various entities, a significant amount of coordination may be involved among the entities, operating multiple computers, in order to bring an app from development to deployment.

### SUMMARY

Certain embodiments of the present technology provide a computer implemented method for managing mobile applications. The method can comprise executing various routines on one or more computers in connection with the mobile applications, for example. In certain embodiments, the method comprises executing a routine that downloads source code from a code repository. The method can also comprise executing a routine that builds the source code to create an executable build. In some embodiments, the method involves executing a routine that performs a check on the executable build according to a defined quality control rule, for example. The method can also comprise the step of executing a routine that communicates the executable build to an application repository. In certain aspects, the method further includes the step of executing a routine that monitors a mobile application development status. The method can also include the step of executing a routine that generates a report communicating the mobile application development status. In certain embodiments, the executing steps can be performed automatically, without manual input from a user.

The present technology also provides systems for developing mobile applications. In certain embodiments, the system comprises a source code downloading tool for automatically downloading source code from one or more code repositories. The system can also include a source code building tool for automatically building source code into executable builds. In certain embodiments, the system can include a quality check tool for automatically performing quality checks on at least one of the source code or the executable builds. In some embodiments, the system comprises a deployment tool that automatically deploys mobile applications to an external source. The system can also include a build success metric tool that generates a build success score for a mobile application, a code quality metric tool that generates a code quality score for the mobile application, and a team activity metric tool that generates a team activity score for the mobile application. In certain aspects, the system comprises a launchability metric tool that generates a launchability score for the mobile application. In operation, the source code downloading tool, the source code building tool, the quality check tool and the deployment tool can be executable by a one or more computer processors.

Certain embodiments of the present technology present mobile application development networks. The mobile application development networks can comprise one or more computers comprising a processor executing a mobile application manager tool. For example, the mobile application manager tool can be one of the systems for developing mobile applications described herein. The mobile application development networks can also comprise one or more code repositories that store source code relating to one or more mobile applications, and one or more application repositories storing executable applications. In some embodiments, the mobile application development networks include a central server connecting the one or more computers, the one or more code repositories and the one or more application repositories.

### BRIEF DESCRIPTION OF THE DRAWINGS

Several features and advantages are described in the following disclosure, in which several embodiments are explained, using the following drawings as examples.

FIG. 1 depicts a high-level block diagram illustrating a network including an example mobile build, quality and deployment manager, in accordance with one or more embodiments of the present disclosure.

FIG. 2 depicts an illustration of a flow chart showing example steps in a method of mobile build, quality and deployment management, according to one or more embodiments of the present disclosure.

FIG. 3 depicts an exemplary screen shot of a dashboard GUI operating a mobile build, quality and deployment management (“MBQDM”) tool in accordance with at least one embodiment of the present disclosure.

FIG. 4 depicts an exemplary screen shot of a build GUI operating a MBQDM tool in accordance with at least one embodiment of the present disclosure.

FIG. 5 depicts an exemplary screen shot of an analytics GUI operating a MBQDM tool in accordance with at least one embodiment of the present disclosure.

FIG. 6 depicts an exemplary screen shot of a deployment GUI operating a MBQDM tool in accordance with at least one embodiment of the present disclosure.

FIG. 7 depicts an exemplary screen shot of a testing GUI operating a MBQDM tool in accordance with at least one embodiment of the present disclosure.

FIG. 8A depicts an screen shot of an exemplary email reporting an unsuccessful project build generated in accordance with at least one embodiment of the present technology.

FIG. 8B depicts an screen shot of an exemplary email reporting a successful project build generated in accordance with at least one embodiment of the present technology.

FIG. 9A depicts an exemplary email reporting a project summary to a team leader as generated in accordance with at least one embodiment of the present technology.

FIG. 9B depicts an exemplary email reporting a project summary to a group executive as generated in accordance with at least one embodiment of the present technology.

### DETAILED DESCRIPTION

Current processes for managing applications from development to deployment have disadvantages. Mobile developers, perhaps even several different entities, may have to spend time to perform various management steps manually, often using several different desktop computers. For example, one entity may manually pull code out of version control system or code repository and then manually compile a mobile build using a desktop computer. That same entity or a different entity may then run mobile code quality checks, likely using a desktop computer. That same entity or a different entity may then manually deploy the builds to internal or external app stores through an external system, such as a web GUI. Therefore, existing application management processes require that all the steps be performed manually, likely by multiple parties, typically different teams for each step in the process, likely using a number of desktop computers. As a result, the monitoring and reporting of this entire process can be disjointed and non-holistic. Moreover, because these process steps are performed by separate entities on separate computer workstations, there is not a convenient way to aggregate these metrics into an overall process metric that can quantify launchability of the application.

The present disclosure describes one or more systems, methods, routines, techniques and/or tools for a mobile application development system, or, more specifically, a mobile build, quality and deployment manager (MBQDM) system that employs monitoring and metrics reporting. In certain aspects of the present technology, the MBQDM can be fully automated. For example, in certain aspects, once the MBQDM is activated, it can automatically checkout and/or download a correct version of code from a version control system and/or code repository. In certain aspects, the MBQDM can then automatically perform any builds on the code, and automatically perform one or more code quality checks, mobile-functional quality assurance checks and/or mobile-user interface quality assurance checks. In certain embodiments, the MBQDM can then automatically deploy the application to a mobile application distributor, such as an app store, or to another finished app repository, or distribute the application via another method. In one or more embodiments of the present disclosure, a user can activate the MBQDM by pressing and/or activating a button or trigger, for example, a systematic trigger. Additionally and/or alternatively, the user can schedule such a triggering event in advance. Once the user activates the MBQDM, the MBQDM can then perform one or more of the steps described herein automatically, for example, without the need of a user performing steps at a desktop computer or providing manual input.

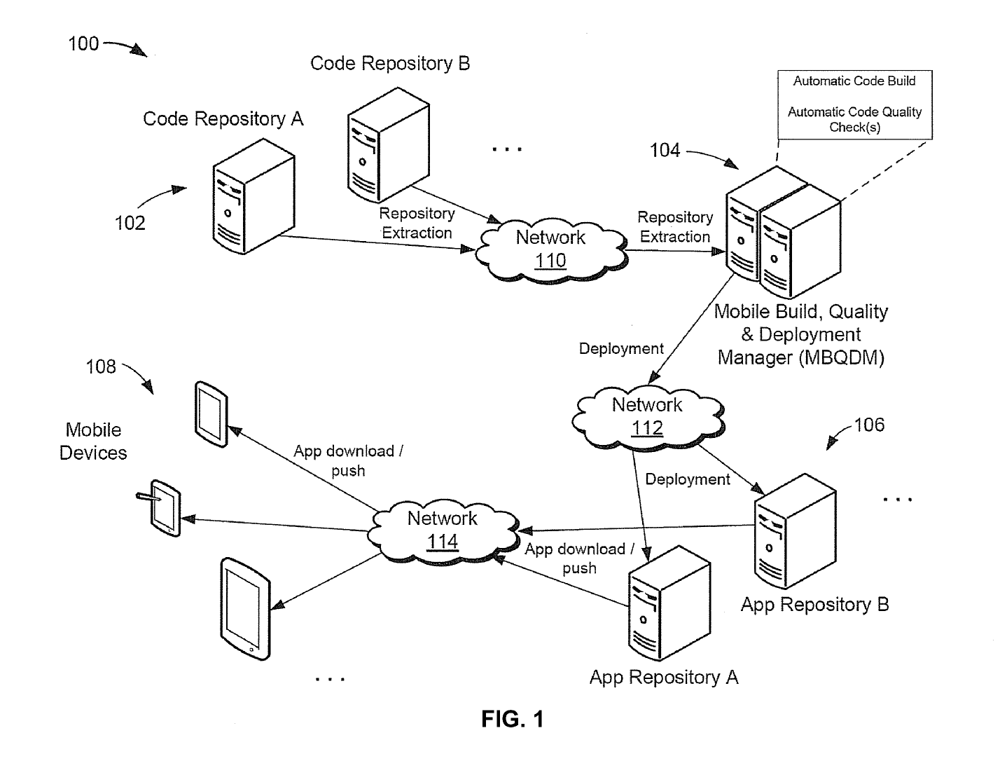

FIG. 1 depicts a high-level block diagram illustrating a network or system 100 including an example MBQDM 104 in accordance with one or more embodiments of the present disclosure. Referring to FIG. 1, the MBQDM 104 may include one or more servers and/or computers and/or data processing units. These computers can act to automatically build code and/or automatically check code quality of an application, for example. FIG. 1 also shows one or more code repositories 102, which can be used to store code that can be automatically extracted by the MBQDM 104 via a network 110, for example. FIG. 1 also shows one or more app repositories 106, which can store executable applications that have been downloaded, built, and quality checked by the MBQDM 104. As shown in FIG. 1, the system 100 may also comprise one or more mobile devices 108 and one or more networks, for example, networks 110, 112, 114, which can provide communication links between the various components of the system 100.

The one or more code repositories 102 may store versions of source code related to one or more mobile applications. The one or more app repositories 106 may store executable applications (apps), for example, applications for which the source code has been downloaded, built and quality checked by the MBQDM 104. The one or more app repositories 106 may be in communication with one or more mobile devices 108 (e.g., cell phones, tablet devices, etc.), for example, via network 114. Mobile devices 108 can download applications and/or updates from one or more of the app repositories 106. In some embodiments, one or more of the app repositories 106 may “push” applications and/or updates to the mobile devices 108.

The MBQDM 104 can communicate with one or more code repositories 102, for example, via a network 110, such that the MBQDM 104 can download and/or extract source code from the code repositories 102. The MBQDM 104 can also communicate with one or more app repositories 106, for example, via a network 112, such that the MBQDM 104 can deploy and/or communicate executable applications. For example, the MBQDM 104 may deploy and/or communicate applications (e.g. applications that have had the source code downloaded, and have been built and quality checked by the MBQDM 104) to one or more app repositories 106. In some embodiments, one or more of the networks 110, 112, 114 may be the same general network, for example the internet.

In certain embodiments, the MBQDM 104 may include one or more central servers and/or computers and/or data processing units. The central server(s) can provide a central location for all the steps required for managing applications from development to deployment. For example, upon activation, the central server(s) can automatically checkout and/or download a correct version of app code from a version control system and/or code repository, such as a repository that is in communication with the central server(s) over the internet. The central server(s) can automatically perform any necessary builds on the code, and can automatically perform one or more code quality and/or mobile-functional quality assurance checks. The central server(s) can automatically deploy one or more customer-ready applications to a mobile app distributor (such as an app store), to another finished app repository, or directly to end users via email or another mode of direct communication, for example. Accordingly, the MBQDM can be designed or adapted to provide all downloading, building, code quality checking and deployment from a centralized (server) environment.

The central server(s) may include one or more processors, one or more storage devices, and communications equipment. In some embodiments, the central server(s) are adapted to perform as a cloud service and/or cloud-based solution. The MBQDM and/or mobile application management described herein can be offered as a Service (“aaS”). That is, the MBQDM can be provided to developers on a fee based service, for example, as a way of managing build, quality checking, and deployment of various applications developed by the developer. The aaS feature provides an alternative to software that is installed on a local computer at the developer. Mobile build and deployment management tools are not offered as a Service to the market. The present disclosure, therefore, describes one or more systems, methods, routines, techniques and/or tools that offer a significant benefit.

In certain aspects of the present technology, the MBQDM 104 gathers and/or generates performance or tracking metrics related to the overall application development process. In certain embodiments, the MBQDM can monitor and generate reports relating to the mobile application development status, which can include the status relating to various aspects and phases of the mobile application development process (e.g., status relating to source code construction, builds, testing, quality assurance, etc.) For example, the MBQDM 104 can determine a build success score based on the rate at which a code is successfully compiled into an executable build. The build success score metric can be scaled, for example, on a scale of 0 to 10 (or 1 to 10), where 10 represents a build that is very successful and 0 (or 1) represents a build that is not very successful. In certain embodiments, the MBQDM 104 can calculate a build success rate based on the percentage of builds over the past 100 days that have been successful, for example.

The MBQDM 104 can also generate code quality metrics, or technical debt metrics. For example, the MBQDM 104 can perform code analysis to determine the number of rules violations that occur in a particular code, and the severity of those violations. In this manner, the MBQDM 104 can generate a code quality score metric that can also be provided, for example, on a scale of 0 to 10 (or 1 to 10), where 10 represents a code with few or no rules violations, and 0 (or 1) represents code having several and/or severe rules violations. In certain embodiments, the code quality score (or technical debt score) can be provided as a percentage, for example, from 0-100 percent.

The MBQDM 104 can also generate team activity metrics. For example, the MBQDM 104 can analyze the quality and quantity of work put into a mobile application by a development team. For example, the MBQDM 104 can calculate how many new lines of code have been added to a particular mobile application over a given period of time (e.g. 10 days or 100 days). In this manner, the MBQDM 104 can generate a team activity score metric, which can also be scaled on a scale of 0 to 10 (or 1 to 10), where 10 represents a very efficient, productive team, and 0 (or 1) represents a team that is not efficiently generating code.

The MBQDM 104 can also develop launchability metrics, which can provide a measure of how ready the mobile application is for launch, release, and/or deployment. In certain embodiments, a launchability score metric can be a compilation of the build success score metric, the code quality score metric and the team activity score metric. The launchability score metrics can represent, for example, the overall mobile application status throughout the development of the mobile application. The launchability score can be provided on a scale of 0 to 10 (or 1 to 10), where 10 represents a mobile application that is ready or nearly ready for launch, and 0 (or 1) represents a mobile application score that is not yet ready for launch.

The launchability score metrics can be reported to executives or other directors of a mobile application developer. In this manner, executives can track the progress of various mobile applications, and develop business strategies based on the launchability score of the particular mobile applications under development. For example, an executive may follow up with a development team of a certain application that has a relatively low launchability score. Additionally and/or alternatively, an executive may decide to expedite the development of a particular application that has a high launchability score in order to move the application to a quicker release date.

In certain embodiments of the present technology, the launchability score can be calculated based on the code quality score (or technical debt), the team activity score, and the build success score. For example, in some embodiments, the code quality score can be calculated as a percentage based on the number of rules violations from quality control, and then inversed and scaled from 0 to 10. For example, a 20% rules violations calculation can translate into a code quality score of an 8. Likewise, in some embodiments, the build success score can be calculated as a percentage of successful builds over a predetermined time period (e.g., two weeks) and then scaled from 0 to 10. For example, a build success percentage of 80% can translate into a build success rate of an 8. And in some embodiments, the team activity score can be calculated based on a deviation of a running ratio of the daily team activity (i.e., the number of new lines of code generated in a single day) divided by an average daily team activity (i.e., the average number of new lines of code generated over a given time period, for example, two weeks). That is, in some embodiments, the team activity score can be assigned a 10 where the daily team activity over a given time period is constant, and a score of 0 if the daily team activity over a given time period displays high deviations. In this manner, each of the code quality score, the build success score and the team activity score can be provided on a scale of 0 to 10. In certain embodiments of the present technology, the launchability score can be compiled by averaging the code quality score (or technical debt), the team activity score, and the build success score. For example, where the code quality score is 8, the build success score is 7, and the team activity score is 3, the launchability score can be 6, as the average of all three scores. In certain embodiments, other methods for determine the launchability score can also be provided. For example, launchability can be compiled based on a weighted average of the scores or on other factors, where weighting is based on what a user, team and/or developer considers to be the most important for an particular project.

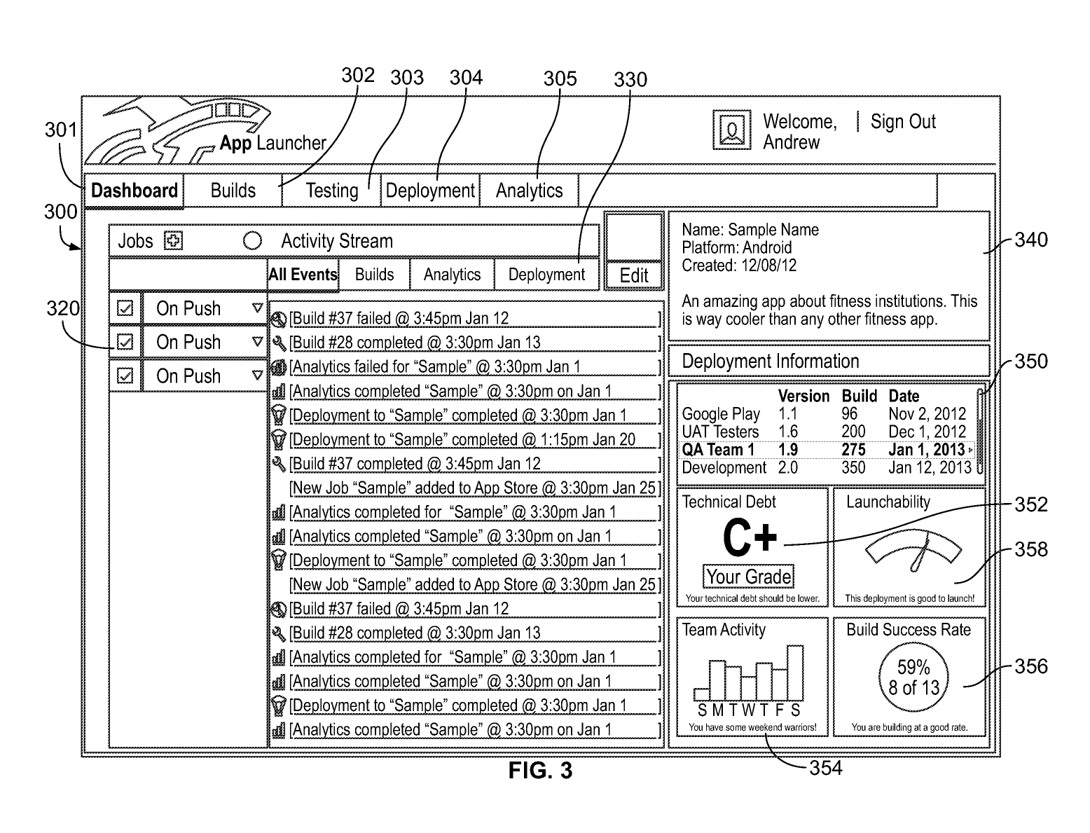

The present technology can be provided to users remotely, for example, via the internet. For example, the present technology can provide a webpage dashboard that provides access to the functionality of the MBQDM, and the reports and metrics that it generates. FIG. 3 depicts a screen shot of a dashboard GUI 300 operating at least one or more functions of a MBQDM of the present technology. As shown in FIG. 3, the GUI depicts a dashboard providing access to an MBQDM (i.e., mobile application development tool). As depicted, the MBQDM includes an app selection menu 310 that allows a user to select an application from a number of applications that the user or a developer may be currently working on. For example, the app selection menu 310 may be a pull-down menu that allows a user to select from various applications operated on various platforms (e.g., Android, iOS, etc.). The GUI 300 can display the name of the project in the project name window 340, for example.

The dashboard GUI 300 also includes a job list 320, or a trigger list. The job list 320 identifies various automated jobs that can be defined by a user, for example. In certain embodiments, the job list 320 can include jobs that instruct the MBQDM to extract source code from a code repository, to build code, to run analytics, or to push or deploy code, builds, or applications to other users or systems, for example.

The dashboard GUI 300 also comprises a status selection bar 330, which allows a user to view activities of various projects based on certain events. For example, the status selection bar 330 can allow a user to view the activities of all events, of builds, or to view analytics or deployments of various projects. Using the status selection bar 330, a user can view whether certain jobs performed by the MBQDM, such as builds, deployments, etc. have been successful.

The dashboard GUI 300 also comprises deployment environment window 350, which can provide logical groupings of people involved with the project, such as developers, testers, user acceptance testers, executives, and/or the general public. The deployment environment can also display statistics and metrics relating to the project. For example, the deployment environment window 350 can display the project's technical debt 352, the team activity rating 354, the build success rate 356 (or the build success score), the launchability score 358, or the code quality score of the application. In this manner, users of the present technology can get a high level overview of the status of a project, and an applications readiness for launch and/or release.

The GUI 300 also includes an interface management toolbar 301 that allows a user to select among various tools and programs of the MBQDM. For example, the user may elect to view the dashboard interface of the MBQDM, which will provide the user with an interface similar to that depicted in FIG. 3. Additionally and/or alternatively, the user can select a number of other interfaces, including, for example, a builds interface 302, a testing interface 303, a deployments interface 304, and an analytics interface 305.

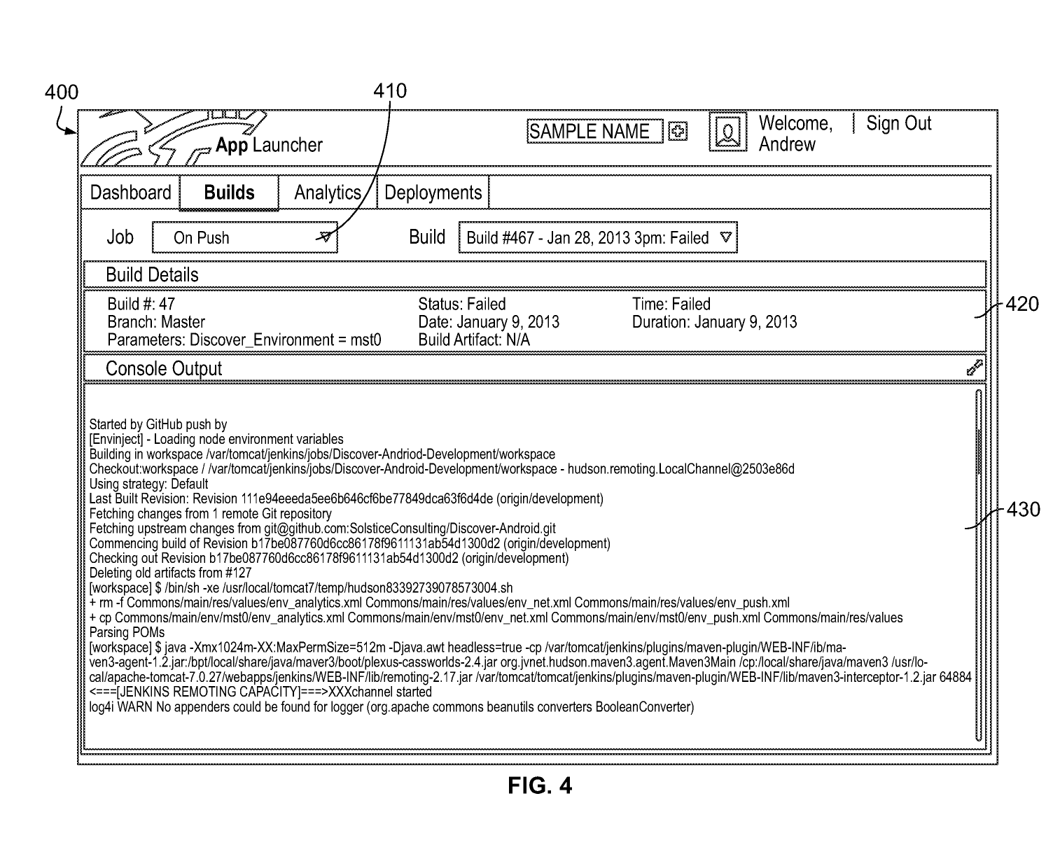

FIG. 4 depicts an exemplary screen shot of an embodiment of the MBQDM displaying the builds GUI 400. As shown in FIG. 4, the builds GUI 400 comprises a job menu 410, which allows a user to look back on the history of a project, or to sort various builds by project. The builds GUI 400 also comprises a build detail window 420, which displays various details about the build associated with the selected project. For example, the build details window provides information about the status of the build (e.g., successful or unsuccessful), the date of the build, the parties notified about the build, the parties that the build was deployed to, the duration of the build, and information related to the number of builds and the build artifacts. The builds GUI 400 also comprises a console output window 430, which provides further details about a build. If and when a project goes wrong, a user can read through the information on the console output window 430 to diagnose the problem.

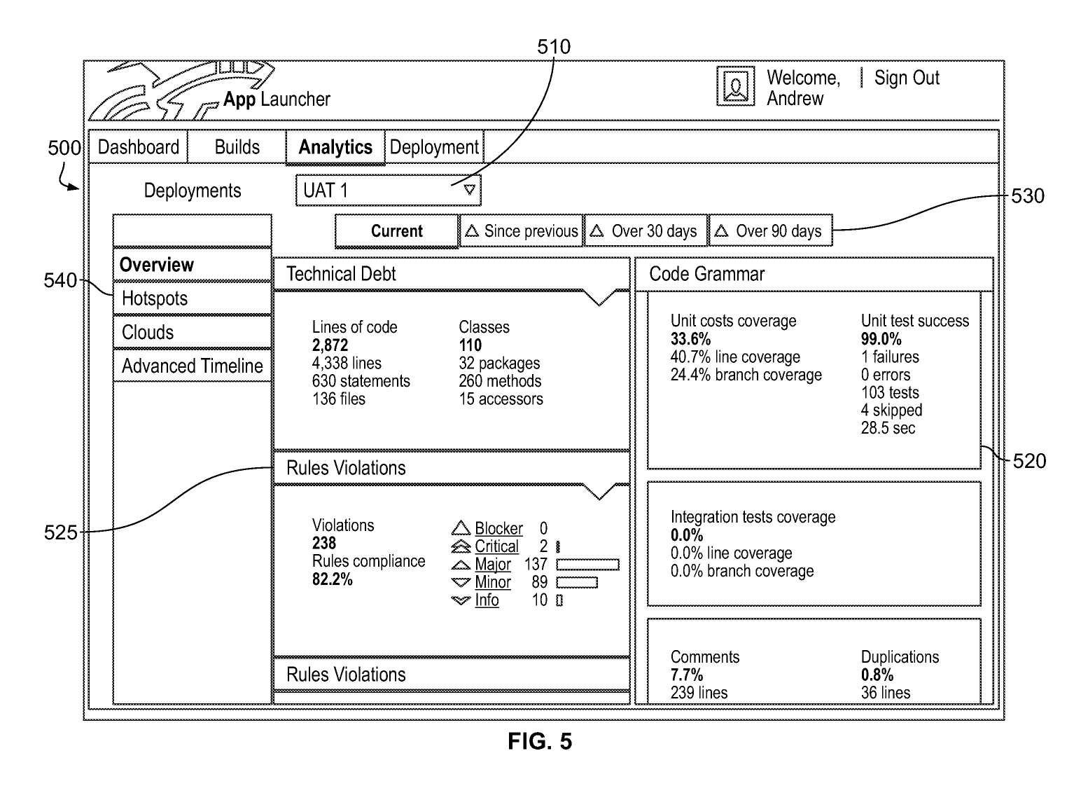

FIG. 5 depicts an exemplary screen shot of an embodiment of the MBQDM displaying the analytics GUI 500. The analytics GUI 500 comprises a deployment selection menu 510 which allows a user to select information deployed to various teams, for example, developers, testers, executives, etc. The analytics GUI 500 further comprises a display window 520 that provides more detailed information about the statistics, metrics, and/or analytics generated by the MBQDM. For example, the display window 520 can provide further details about how a particular project's technical debt, rules violations and/or code quality score, code grammar information, team activity score, the build success score, or the launchability score was compiled. In certain embodiments, the analytics GUI can provide links to the source code or to the builds that can directly link a user to the portions of the project that are causing problems with the score. For example, where a source code has resulted in rules violations that result in a decreased code quality score, the analytics GUI 500 can provide links 525 to the portions of the source code that are causing the code quality score to be decreased. In certain aspects, a user may be able to view the analytics over a given time period via the timeline selection bar 530. A user may also elect to view analytics using different visualizations such as hotspots, or clouds, or the user can view the analytics over an advanced timeline via an overview selection list 540.

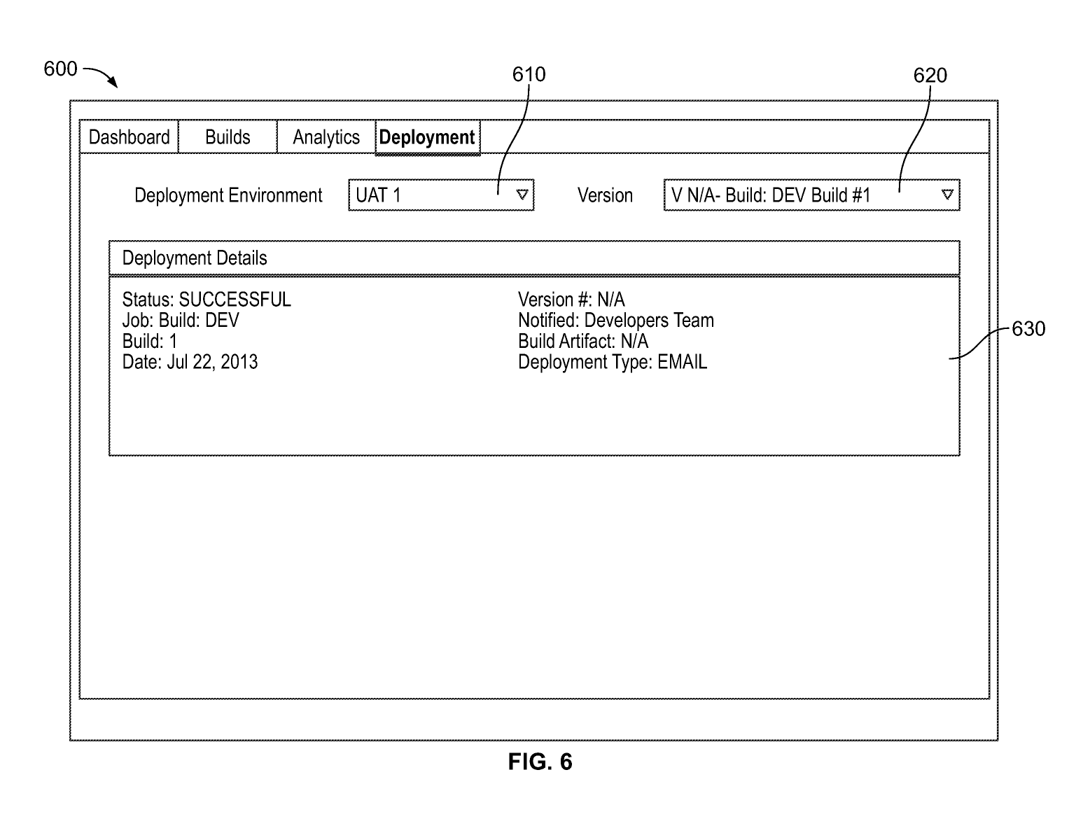

FIG. 6 depicts an exemplary screen shot of an embodiment of the MBQDM displaying the deployment GUI 600. The deployment GUI 600 can comprise a deployment environment selection menu 610, which provides a list of various teams, groups, and/or individuals that have received, or are able to receive the deployed information. For example, the deployment environment selection menu can provide a list that includes developers, testers, user acceptance testers, executives, and/or the general public. The deployment GUI 600 can also include a version selection menu 620, which allows a user to select various versions of a project that can be or have been deployed. The deployment GUI 600 also includes a deployment details window 630 which displays the deployed information. For example, the deployment details window 630 can provide information relating to various jobs performed on the project including the job description and the status of the job, the date of the job, and various groups that may have been notified about the job.

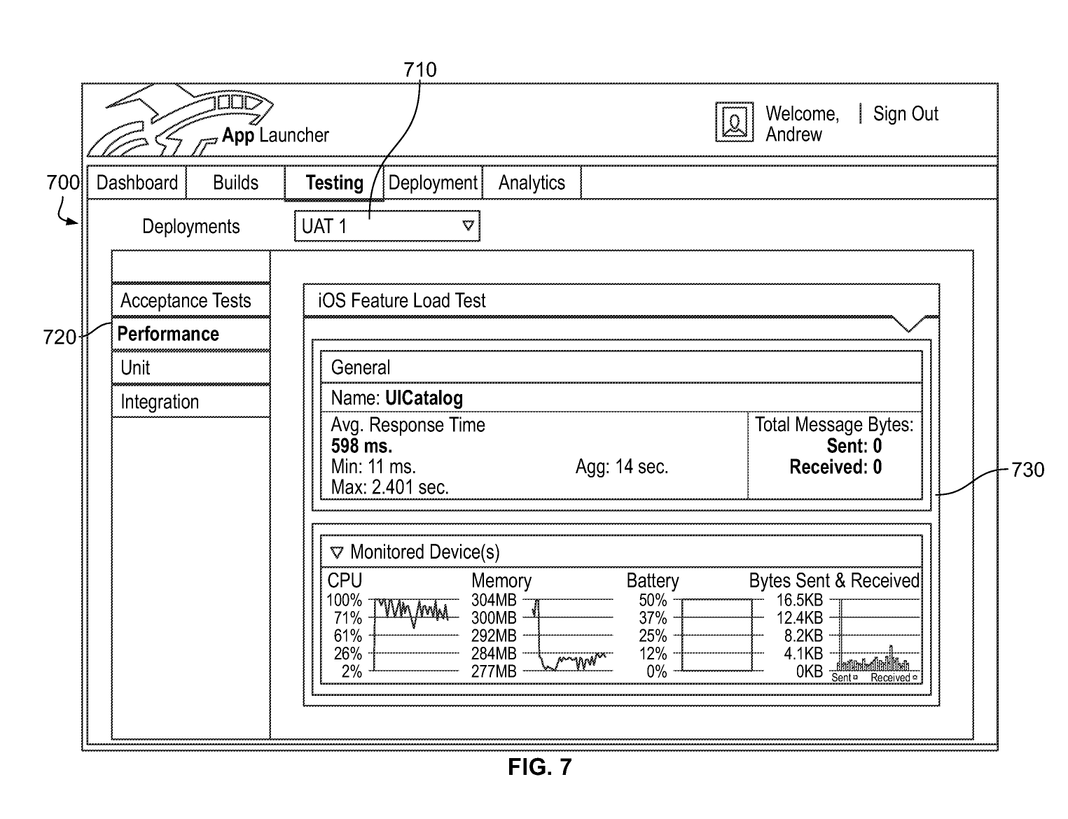

FIG. 7 depicts an exemplary screen shot of an embodiment of the BQDM displaying the testing GUI 700. The testing GUI 700 can comprise a deployment selection menu 710, which provides a list of various teams, groups, and/or individuals that have received, or are able to receive the testing information. The testing GUI 700 can also comprise a test selection menu 720 that allows provides a user with various options for viewing test results. For example, using the test selection menu 720, a user can elect to view acceptance tests, performance, tests based on units, or an integration of tests. The testing GUI 700 also comprises a test results window 730 that provides results from the various tests performed by the MBQDM.

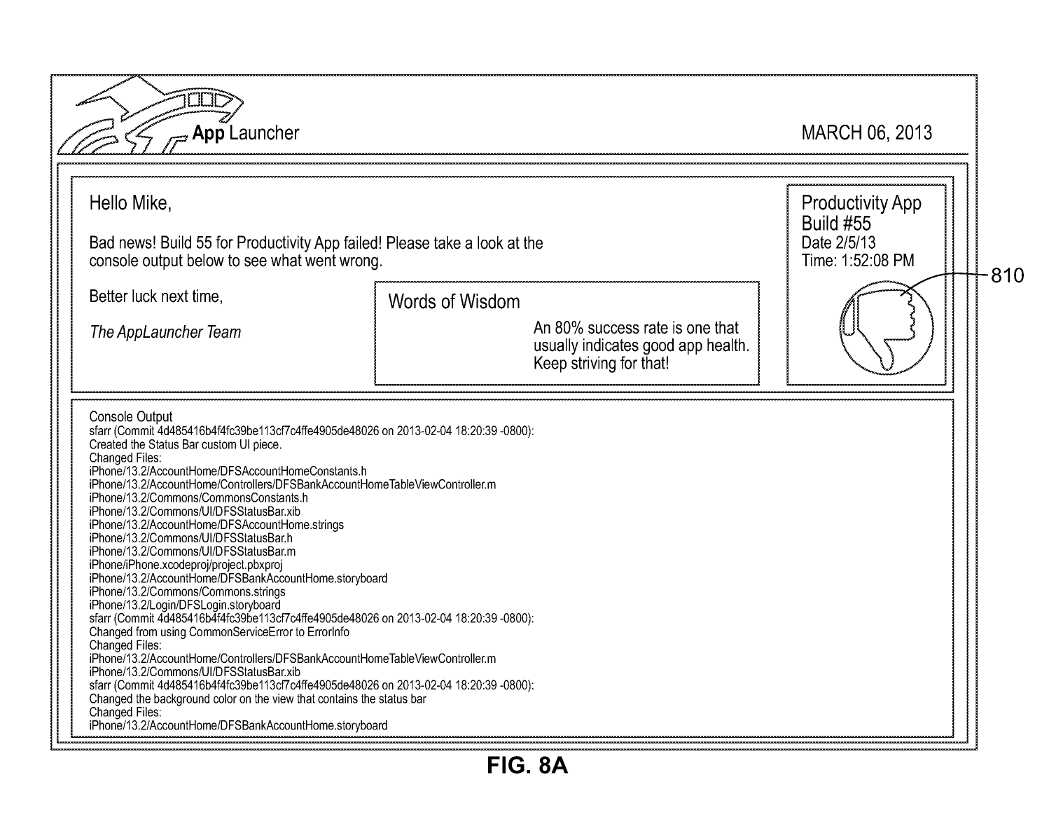

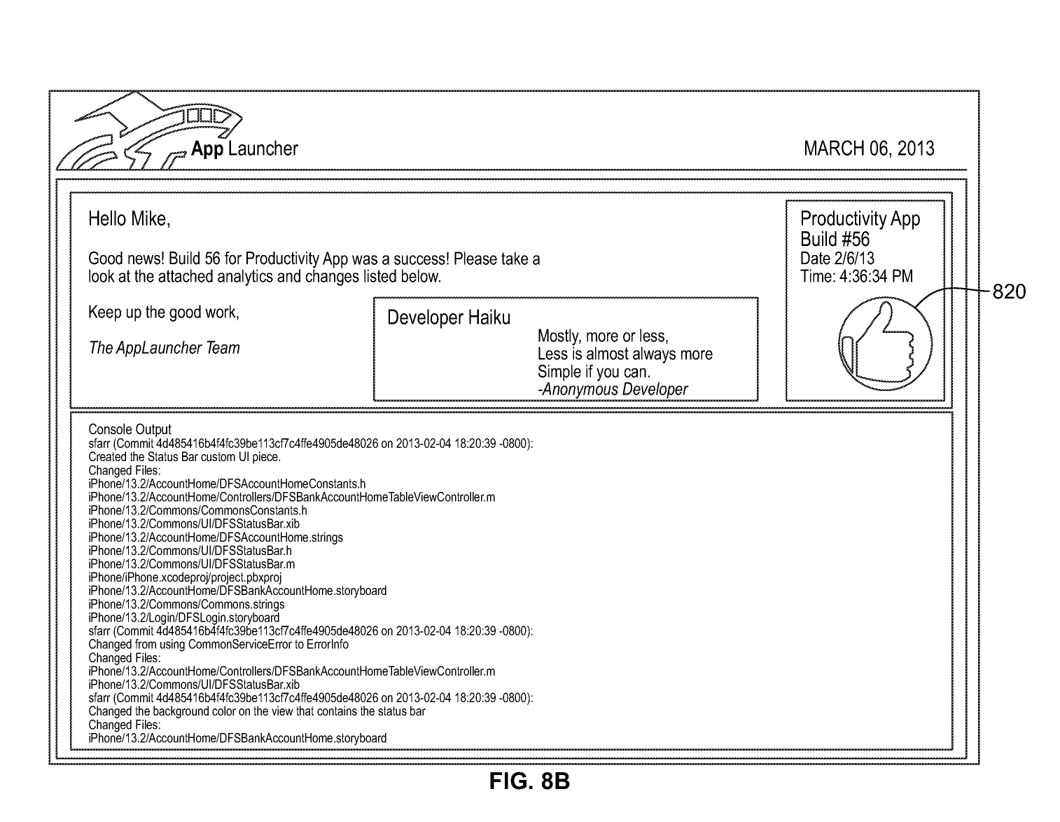

The present technology can also be adapted to generate reports and/or communications based on the status and development of mobile applications. FIGS. 8A and 8B depict screen shots of exemplary emails reporting and project builds generated by the MBQDM. As shown in FIGS. 8A and 8B, the MBQDM can generate emails and/or other communications that identify the name of the project, the job, and the results of the job. FIG. 8A depicts a reporting email that reports an unsuccessful build, as indicated by the “thumbs-down” icon 810 in the email. Conversely, FIG. 8B depicts a reporting email that reports a successful build, as indicated by the “thumbs-up” icon 820.

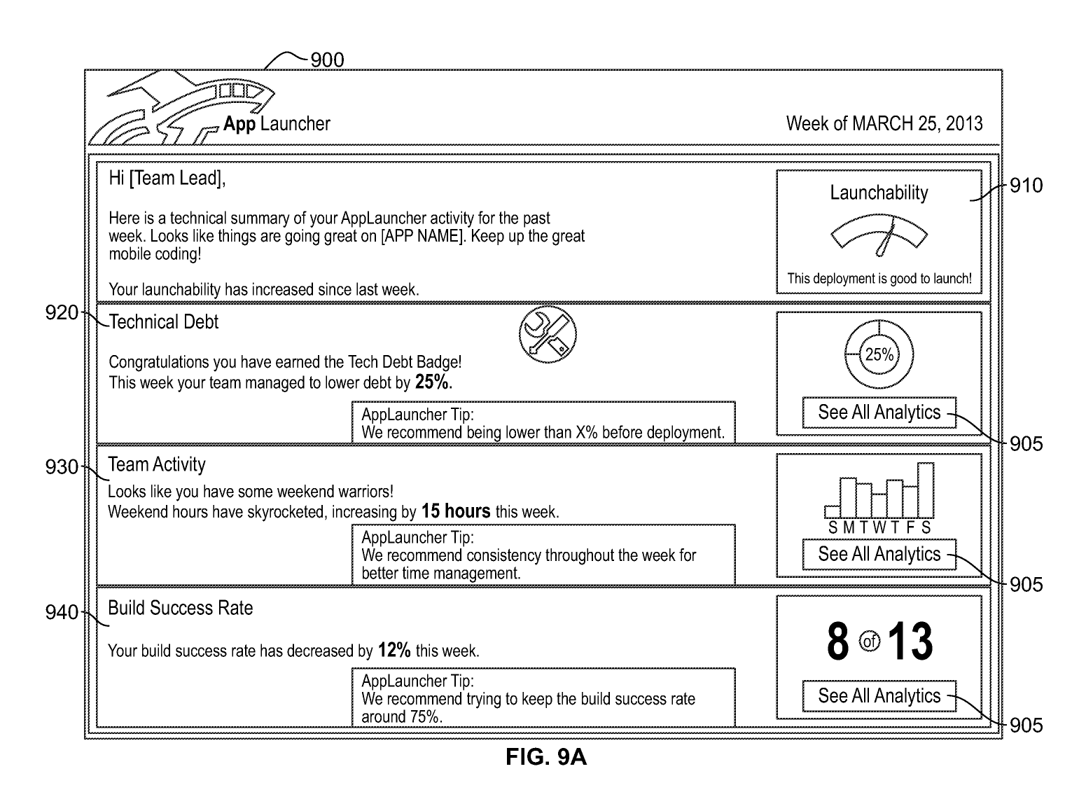

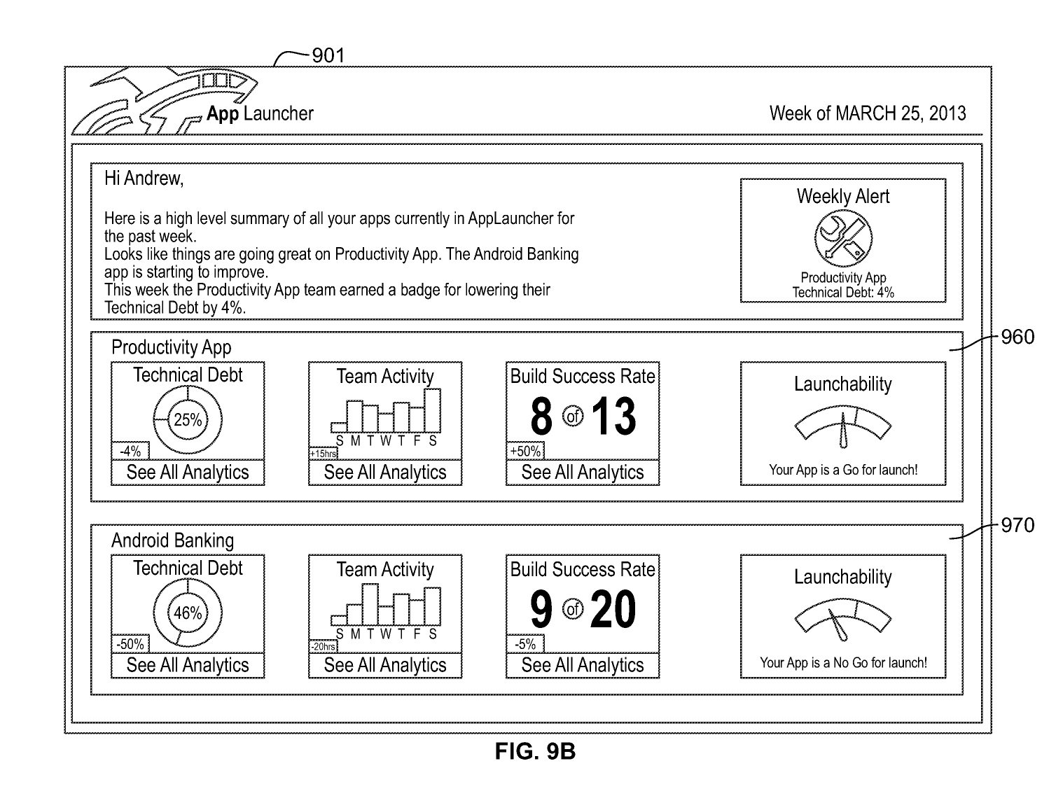

FIGS. 9A and 9B depicts screen shots of other exemplary reporting emails that can be customized to specific targets, or team members. For example, FIG. 9A depicts an exemplary email reporting a project summary to a team leader as generated by an MBQDM. More specifically, FIG. 9A provides a team leader email 900, which contains information that is expected to be useful to mobile application development team leader. For example, in FIG. 9A, the launchability metric 910 is provided at the top of the report along with a graphical depiction (depicted as a gauge) of the overall launchability score. The team leader report 900 also comprises textual and graphical information related technical debt 920, team activity 930, and build success rate 940. Within each of these metrics, the team leader is invited to “see all analytics.” In this manner, a user can, for example, click on the “see all analytics” button 905 and be directed to a website, file, directory, document or other program that provides more detailed information on how the related metric was compiled.

Similarly, FIG. 9B depicts an exemplary email 901 reporting a project summary to a group executive as by the MBQDM. As shown in FIG. 9B, the executive reporting email 901 can contain different information, and can provide it in a different format than the team leader reporting email 900. Because an executive may be responsible for overseeing multiple projects, in certain embodiments it may be desired to provide reporting emails on a higher level than that of the team leader reporting emails. For example, the executive reporting email may report condensed metrics on a variety of projects (e.g. 960 and 970), as opposed to the team leader email, which includes more details about each of the metrics for one specific project.

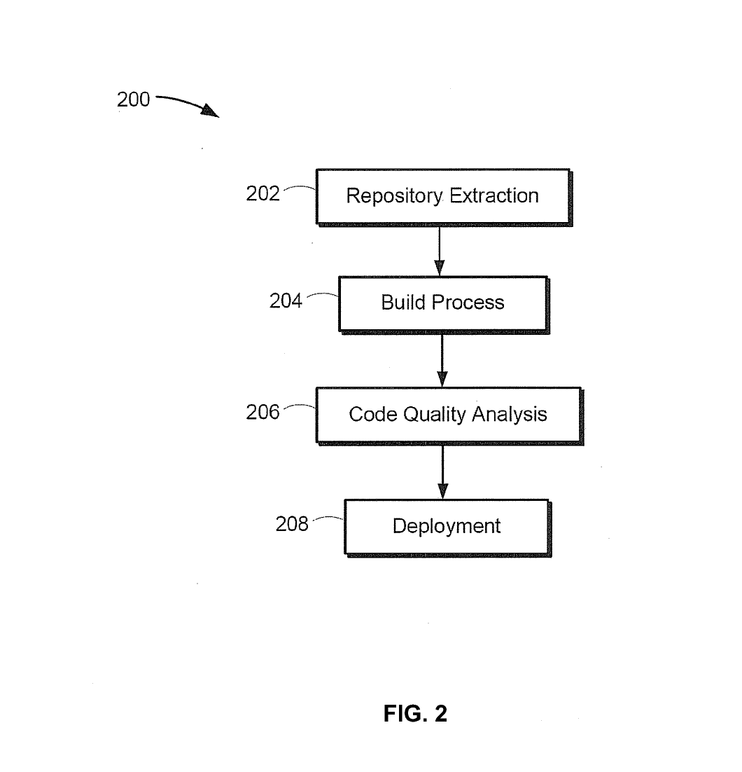

Certain embodiments of the present disclosure may be found in one or more methods of mobile application management. FIG. 2 depicts an illustration of a flow chart 200 showing example steps in a method of mobile application management, according to one or more embodiments of the present disclosure. It should be understood that, in some embodiments, one or more of the steps depicted in FIG. 2 may be performed in a different order than depicted. Additionally, in some embodiments, a method of mobile application management may include more or less steps than are depicted in FIG. 2.

At step 202, the mobile build, quality and deployment manager (MBQDM) can checkout and/or download a correct version of app code from a version control system and/or code repository, for example, a repository in communication with the central server(s) over the internet. This step 202 may be referred to as repository extraction. A code repository may refer to a storage facility for developers to store source code. The MBQDM can be adapted to extract, pull, and/or download source code from several different compatible code repositories, for example, a API-enabled code repository. Examples of code repositories that may be compatible with the MBQDM includes Subversion, Git, Microsoft TFS, CVS, or any other API-enabled code repository. The MBQDM can pull source code from a code repository and automatically feed the source code to a build process (step 204).

At step 204, the MBQDM can automatically perform any necessary builds on the code that it extracted at step 202. The MBQDM can be adapted to compile source code from several different coding projects into an executable build. For example, the MBQDM can be adapted to compile the following coding projects into an executable build: Apple iOS, Google Android and/or Glass (GDK), Microsoft's various Windows Mobile OS's, Adobe's PhoneGap, Adobe's Flex, and/or any other coding project.

At step 206, the MBQDM can perform one or more code quality and/or mobile-functional quality assurance checks. For example, a compiled build can be ran through many different types of quality assurance checks. This step may be referred to as code quality analysis. At step 206, code can be analyzed against a set of standardized coding rules, for example, rules specific to the programming language used. This code quality analysis step can ensure that best industry practices are used, for example, so that the code is supported to the fullest extent. Proper code quality analysis can also ensure that the code is complete and that the code is written in a manner that makes optimal use of memory (memory management). Because all code quality analysis may be performed on one or more central servers, a user can define a central set of code quality controls (i.e. coding rules, checks, etc.). At step 206, executables, for example executables built at step 204 from code extracted at step 202, can be run against a set of pre-defined unit and functional tests, for example, to ensure code quality.

Code quality controls (i.e. coding rules, checks, etc.) can be centrally defined, for example, in one location for all applications related to a particular entity. As an example, a company may define a central set of code quality controls for all the applications in the company's app catalog. This can allow the company to achieve consistency across applications, and may allow the company to adhere to similar rules across development teams. The MBQDM can also be adapted to manage more than one set of rules for a particular entity or account. For example, one set of rules may check for coding best practices based on the programming language being used. As another example, one or more sets of rules may be defined where each set is specific to an organization, department, and/or team or to a particular project. As another example, one or more sets of rules may be defined for individual units of code and/or for the systematic level and/or for one or more user interfaces. The MBQDM can run checks on individual units of code, on a systematic level and/or on one or more user interfaces.

In some embodiments, one or more error reports or quality assurance outputs can be communicated to one or more recipients. The error reports may be based on and/or reflect rules that were broken in a particular source code. In some embodiments, rules can be assigned severity levels. In some embodiments, the MBQDM may calculate the cost and time to fix indicated errors and may include this information in an error report. The recipients may be involved in the development and/or deployment of the application. The reports and/or quality assurance outputs can be communicated by email or otherwise to a recipient list, for example a list of email addresses that have been determined ahead of time. The MBQDM can also interact with a calendar program, for example, an online calendar application such as Google Calendar. In response to a build pass or fail, the MBQDM can cause a calendar event to be created. The MBQDM can also interact with external bug repositories, and the MBQDM can define entries in such an external bug repository. In some aspects of the present technology, the MBQDM can also interact with external requirements gathering applications. In this manner, the MBQDM can report adherence and traceability metrics.

At step 208, the MBQDM can deploy an application, for example, a customer-ready application, to a mobile application distributor (e.g., an app store) or some other finished app repository. This step may be referred to as deployment. Once a build and/or executable has passed code quality checks (step 206), the build may be deployed or “pushed out” as a mobile application. At step 208, fully tested builds and/or executables can be automatically deployed and/or communicated to one or more locations, for example, via the internet, an intranet or some other connection. In one or more embodiments, fully tested builds and/or executables can be automatically deployed to an internal app store, for example, via an intranet. As an example, an internal app store can be serviced by Mobile Application Management Vendors. In one or more embodiments, fully tested builds and/or executables can be automatically deployed to an external app store, for example, via the internet. Examples of external mobile application distributors or app stores are the Apple App Store, Google Play, Amazon App Store, or any other finished app repository. In one or more embodiments, fully tested builds and/or executables can be automatically deployed to test devices or internal employees that may test the finished application. In certain embodiments, the MBQDM can integrate with and/or communicate with any application repository that has an API. In some embodiments, the MBQDM can email, or notify by other means, a build master with instructions prompting the build master to manually upload a successful build. In some embodiments the MBQDM can send a build through over the air test deployment systems, for example, TestFlight and HockeyApp. In certain embodiments, the MBQDM can also act as an over the air test deployment system itself.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, it is also understood that the embodiments shown in the drawings, if any, and as described above are merely for illustrative purposes and not intended to limit the scope of the invention. As used in this description, the singular forms “a,” “an,” and “the” include plural reference such as “more than one” unless the context clearly dictates otherwise.

1. A computer implemented method for managing mobile applications, the method comprising executing the following steps on one or more computers:
executing a routine that downloads source code from a code repository;
executing a routine that builds the source code to create an executable build;
executing a routine that performs a check on the executable build according to a defined quality control rule;
executing a routine that communicates the executable build to an application repository;
executing a routine that monitors a mobile application development status; and
executing a routine that generates a report communicating the mobile application development status;
wherein the executing steps occur automatically without manual input from a user.

2. The computer implemented method of claim 1, wherein the overall mobile application status is based at least part on a status of the mobile application build, a status of the mobile application quality, and a status of the mobile application deployment.

3. The computer implemented method of claim 1, wherein the step of executing a routine that generates a report communicating the overall mobile application status further comprises the steps of:
executing a routine that generates a build success score;
executing a routine that generates a code quality score;
executing a routine that generates a team activity score; and
compiling a launchability score based at least in part on the build success score, the code quality score, and the team activity score.

4. The computer implemented method of claim 3, wherein the build success score is based on a rate at which a code is successfully compiled into an executable build.

5. The computer implemented method of claim 3, wherein the code quality score is based on a number of detected rules violations that occur in a particular code, and a determined severity level of the rules violations.

6. The computer implemented method of claim 3, wherein the team activity score is based on a number of new lines of code added to a mobile application over a period of time.

7. The computer implemented method of claim 3, wherein each of the build success score, the code quality score and the team activity score are provided on a scale of 0 to 10.

8. The computer implemented method of claim 7, wherein the launchability score is compiled based on a weighted average of the build success score, the code quality score, and the team activity score.

9. The computer implemented method of claim 1, wherein the executing steps are performed via a central server.

10. The computer implemented method of claim 9, wherein the executing steps are performed as a Service on one or more computers that are not local to computers used to generate the source code.

11. A system for developing mobile applications comprising;
a source code downloading tool for automatically downloading source code from one or more code repositories;
a source code building tool for automatically building source code into executable builds;
a quality check tool for automatically performing quality checks on at least one of the source code or the executable builds; and
a deployment tool for automatically deploying mobile applications to an external source;
wherein the source code downloading tool, the source code building tool, the quality check tool and the deployment tool are executable by a one or more computer processors.

12. The system of claim 12, further comprising:
a build success metric tool for generating a build success score for a mobile application;
a code quality metric tool for generating a code quality score for the mobile application;
a team activity metric tool for generating a team activity score for the mobile application; and
a launchability metric tool for generating a launchability score for the mobile application.

13. The system of claim 12, wherein the build success score is based on a rate at which a code is successfully compiled into an executable file, wherein the code quality score is based on a number of detected rules violations that occur in a particular code, and a determined severity level of the rules violations, and wherein team activity score is based on a number of new lines of code added to a mobile application over a period of time.

14. The system of claim 13, wherein each of the build success score, the code quality score and the team activity score are provided on a scale of 0 to 10.

15. The system of claim 14, wherein the launchability metric tool compiles the launchability score based on the build success score, the code quality score, and the team activity score.

16. The system of claim 15, wherein the launchability metric tool compiles the launchability score based on a weighted average of the build success score, the code quality score, and the team activity score.

17. A mobile application development network comprising:
one or more computers comprising a processor executing a mobile application manager tool;
one or more code repositories storing source code relating to one or more mobile applications;
one or more application repositories storing executable applications; and
a central server connecting the one or more computers, the one or more code repositories and the one or more application repositories.

18. The mobile application development network of claim 17, wherein the mobile application manager tool comprises a:
source code downloading tool for automatically downloading source code from the one or more code repositories;
a source cold building tool for automatically building source code into executable mobile applications;
a quality check tool for automatically performing quality checks on at least one of the source code or the mobile applications; and
a deployment tool for automatically deploying the mobile applications to an external source.

19. The mobile application development network of claim 18, wherein the mobile application manager tool further comprises:
a build success metric tool for generating a build success score for a mobile application;
a code quality metric tool for generating a code quality score for the mobile application;
a team activity metric tool for generating a team activity score for the mobile application; and
a launchability metric tool for generating a launchability score for the mobile application.

20. The mobile application development network of claim 19, wherein the build success score is based on a rate at which a code is successfully compiled into an executable file, wherein the code quality score is based on a number of detected rules violations that occur in a particular code, and a determined severity level of the rules violations, and wherein team activity score is based on a number of new lines of code added to a mobile application over a period of time,
and further wherein the launchability metric tool compiles the launchability score based on a weighted average of the build success score, the code quality score, and the team activity score.
